(19) United States
(12) Patent Application Publication
(10) Pub. No.: US 2008/0021672 A1
(43) Pub. Date: Jan. 24, 2008

(54) Scanning an Object

(75) Inventors: David Graham Powley, Bristol (GB); Nigel Stephen Workman, Bristol (GB)

Correspondence Address: OLIFF & BERRIDGE, PLC, P.O. BOX 320850, ALEXANDRIA, VA, 22320-4850, US

(73) Assignee: Renishaw plc, Wotton-Under-Edge (GB)

(21) Appl. No.: 10/590,880

(22) PCT Filed: Mar. 11, 2005
(86) PCT No.: PCT/GB05/00965

§ 371 Date: Aug. 28, 2006

(30) Foreign Application Priority Data
Mar. 18, 2004 (GB) 0406110.7
Mar. 23, 2004 (GB) 0406493.7

(51) Int. Cl. G01B 5/008; G01B 21/04; G05B 19/401

(52) U.S. Cl. 702/158; 33/503

(57) ABSTRACT

A method and apparatus for scanning an object (10) with a surface measurement probe (26) mounted on a coordinate positioning machine (24). Translational movement of the coordinate positioning machine (24) is used to move the probe along an at least part nominally spiral path about an axis (14) which intersects the object (10). The servo direction vector (16) for the probe (26) is directed nominally towards the axis (14) of the at least part nominally spiral path. The servo direction vector (16) for the probe is at an angle to said axis (14) of the nominally spiral path and at an angle to a plane perpendicular to said axis of the at least part nominally spiral path, which enables scanning of surfaces both parallel and perpendicular to the axis without the probe slipping off the surface of the object.

The present invention relates to a method and apparatus for scanning an object using a surface measurement probe mounted on a coordinate positioning apparatus. Coordinate positioning apparatus includes, for example, coordinate measuring machines (CMM), machine tools, manual coordinate measuring arms, scanning machines and inspection robots.

The method and apparatus of the present invention is suitable for scanning teeth and dental parts.

It is known to measure an object by using a surface measurement probe mounted on a coordinate positioning apparatus, for example coordinate measuring machines. The measurement data of the surface of the object thus determined provides a 3D map of the surface of the object.

A first known method of scanning the surface of an object comprises moving the surface measurement probe along a single direction, for example the x axis, and following the surface of the object along that axis with the probe. This scan provides measurement data along a single plane. To obtain measurement data in the adjacent plane the surface measurement probe must be stopped and reversed to repeat the scan in the next plane and in successive planes, giving a raster scan over the whole surface. This method has the disadvantage that it is slow due to the requirement to stop and reverse the surface measurement probe at the end of each plane.

Another method for scanning the surface of an object comprises moving the surface measurement probe around the surface of the object in the xy plane and repeating the step for adjacent slices of the object translated in the z direction. This method is also slow. It has the further disadvantage that as the probe force is in the xy plane, then if the top surface is horizontal it cannot be measured using the same scan profile, as the probe will slip on the horizontal surface. To overcome this, a separate scan profile is required for the top surface

Our earlier International Patent Application No. WO03/046412 discloses a method of scanning a sample in which the sample is positioned on a mount which is provided with a generally helical screw-thread so that the mount and the sample rotate in a helical path. A probe is positioned at a suitable point on the surface of the sample so that on rotation of the mount, a spiral scan is produced of the sample.

This method is limited due to its mechanical nature as it requires a particular mechanical set-up and, for example, the thread pitch cannot be adjusted.

The present invention provides a method for scanning an object with a surface measurement probe mounted on a coordinate positioning machine, the probe having a definable servo direction vector, the method comprising the steps of:
using translational movement of the coordinate positioning machine to move the probe along an at least part nominally spiral path about an axis which intersects the object;
wherein the servo direction vector for the probe is directed nominally towards the axis of the at least part nominally spiral path;
and wherein the servo direction vector for the probe is at an angle to said axis of the nominally spiral path and at an angle to a plane perpendicular to said axis of the at least part nominally spiral path.

As the servo direction vector of the probe is at an angle to both the axis of the nominally spiral path and the plane perpendicular to said axis, this enables scanning of surfaces both parallel and perpendicular to said axis, without the probe slipping off the surface of the object. This is particularly important for objects such as teeth in which information is required from both the tip and side surfaces. The servo direction vector is directed nominally towards the axis of the nominally spiral path to prevent probe slippage.

The object may have an unknown surface profile. The object may have a free form surface.

This method has the advantage that the spiral profile provides a continuous and fast scan.

Furthermore, this method may be carried out on any coordinate positioning apparatus as no mechanical parts are required to form the spiral scan profile.

As the spiral scan profile is not defined by mechanical parts, the profile dimensions can easily be adjusted, such as pitch of spiral and angle of the second axis.

The surface measurement probe may comprise a contact probe having a deflectable stylus. In this case the method may comprise a further step of moving the probe parallel to the direction of the probe servo direction vector of the probe to control probe deflection.

The surface measurement probe may comprise a non contact probe. The method may comprise the further step of moving the probe parallel to the direction of the probe servo direction vector of the probe to control probe offset. As the non contact probe moves along the at least part nominal spiral path, it may be rotated to keep its line of sight directed towards the axis which intersects the object.

The method may comprise the step of maintaining the probe on the nominally spiral path by movement of the probe perpendicular to the direction of the servo direction vector of the probe.

In one embodiment, translational movement of the coordinate positioning machine to move the probe along an at least part nominally spiral path about an axis which intersects the object is achieved by: defining a second axis along which the probe servo direction vector is parallel, said second axis being at an angle to said axis which intersects the object; rotating the second axis for an at least part revolution about the first axis and translating the second axis in a direction parallel to the first axis; moving the surface measurement probe to keep it on the axis. The second axis may intersect the surface of the object to be measured.

The servo direction vector of the probe may be angled at 45 degrees to the axis intersecting the part.

The angle between the probe direction vector and the axis which intersects the object may be varied during the scan.

The surface measurement probe may comprise a non-contact probe, for example an optical, capacitance or inductance probe.

A second aspect of the present invention provides a method for scanning an object with a surface measurement probe comprising the steps of:
defining a first axis of the object;
defining a second axis, said second axis being at an angle to the first axis;
rotating the second axis for an at least part revolution about the first axis and translating the second axis in a direction parallel to the first axis;
moving the surface measurement probe to keep it on the second axis.

The probe may be servoed in the direction of the second axis to keep the probe at the desired distance from the object. The probe may be servoed in a direction perpendicular to the second axis to keep the probe on the second axis.

Preferably the second axis intersects the surface of the object to be measured.

A third aspect of the present invention provides an apparatus for scanning an object comprising:
a surface measurement probe mounted on a coordinate positioning machine, said coordinate positioning machine having drive means to enable the probe to be driven translationally in several axes;
a controller which controls said drive means to move the probe along an at least part nominally spiral path about an axis which intersects said object;
wherein the controller controls the drive means such that the servo direction vector of the probe is directed nominally towards the centre of said axis of the at least part nominally spiral path;
and wherein the controller controls the drive means such that the servo direction vector of the probe is at an angle to said axis of the at least part nominally spiral path and at an angle to a plane perpendicular to said of the at least part nominally spiral path.

Preferred embodiments of the invention will now be described by way of example with reference to the accompanying drawings, wherein:

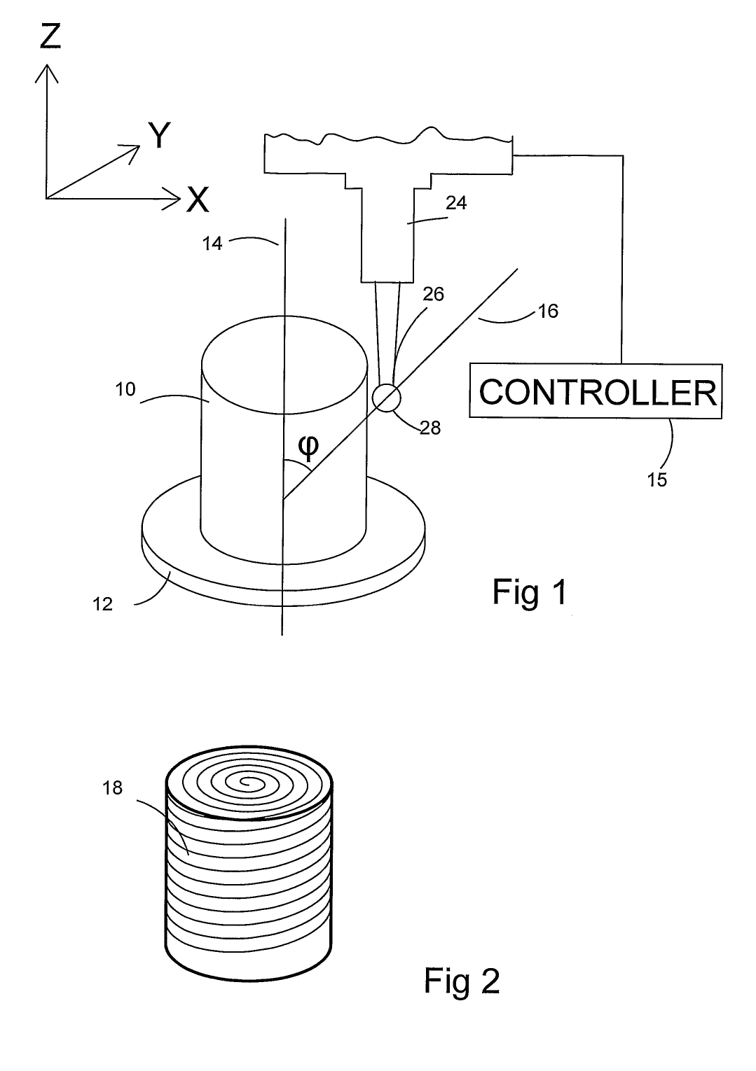

FIG. 1 is a perspective view of the object to be scanned;

FIG. 2 illustrates the spiral scan profile;

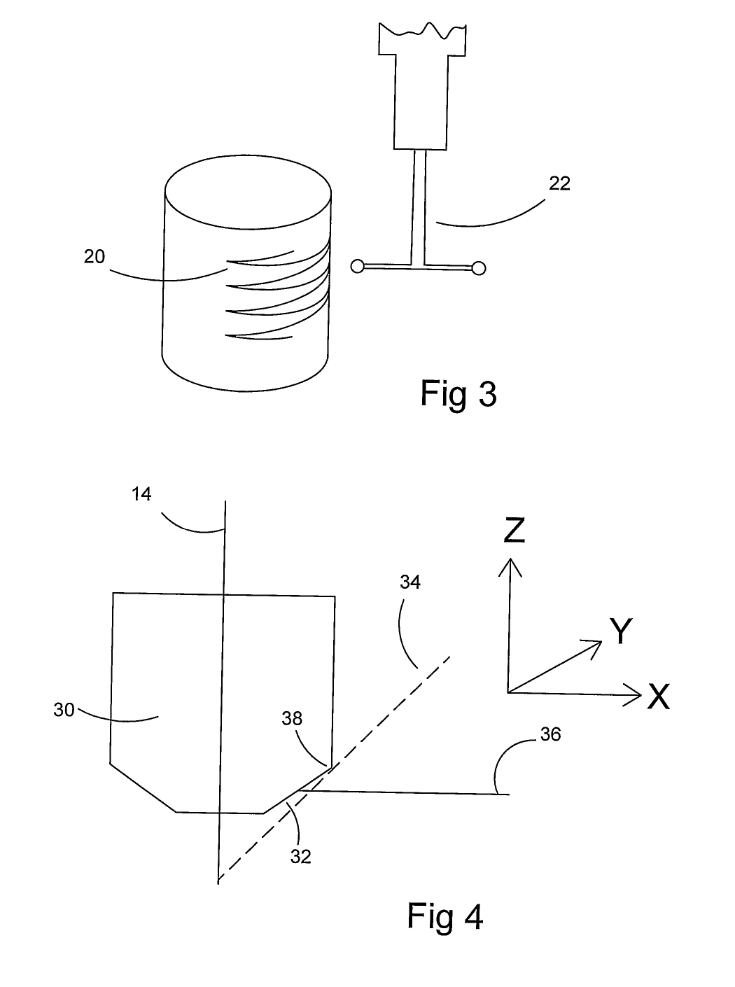

FIG. 3 illustrates the scan profile for a series of half revolutions of the second axis;

FIG. 4 illustrates measurement of a surface having an undercut; and

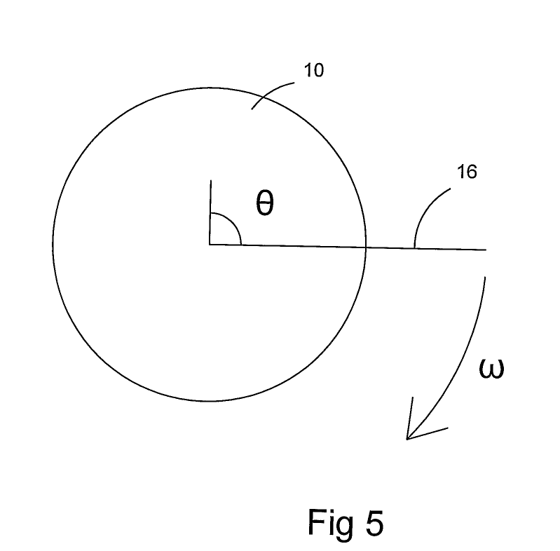

FIG. 5 illustrates a plan view of the scan profile.

As illustrated in FIG. 1 an object 10, to be measured e.g. a tooth, is mounted 12 on a mount of the coordinate positioning apparatus. The coordinate positioning apparatus has drive means (not shown) which enable translational movement of a probe 24 mounted on it along the x,y and z axes. Such movement is controlled by a machine controller 15. An axis of rotation 14 of the object is specified by the user. This may for example be the z axis of the part coordinate system of the object. The rotational axis 14 may be defined with respect to the mount 12 by the object 10 being mechanically aligned to this axis when mounted on the mount. A second axis 16 is defined which is at an angle φ to the rotation axis 14 and which intersects the surface of the object 10. The second axis 16 may be at any angle to the rotation axis 14 (but not parallel) and FIG. 1 shows the second axis being at 45°. The second axis 16 is rotated about the axis of rotation 14 and is translated parallel to the axis of rotation 14 thus creating a spiral profile. FIG. 2 illustrates the spiral profile 18 created by this movement of the second axis about the axis of rotation. As described in more detail below, a probe is moved along the spiral profile created by the movement of the second axis to scan the object along this spiral profile. FIG. 3 illustrates the scan profile 20 created when the second axis is rotated a part revolution about the axis of rotation and translated parallel to the axis of rotation. This scan profile is suitable for use with a probe having a T stylus 22 as illustrated. A surface measurement probe 24 is mounted on the coordinate positioning apparatus for relative movement with respect to the mount 12. The probe 24 has a deflectable stylus 26 with a surface contacting tip 28.

The probe 24 follows the spiral profile created by movement of the second axis 16 and thus scans the object 10 by following a spiral profile.

The servo direction vector of the probe is directed along this second axis. This is the direction in which the probe is servoed by the coordinate positioning apparatus to control the stylus deflection of the probe (or for a non-contact probe, to control the offset of the probe.)

Movement of the probe is controlled by an algorithm having two components. The first component keeps the probe on the second axis. This is accomplished by determining the position of the stylus tip of the probe, determining the nearest position on the second axis to the stylus tip and moving the probe in a direction perpendicular to the second axis back onto the second axis.

The second component of the algorithm controls the probe deflection. In this case the probe is moved parallel to the second axis to provide the desired probe deflection.

Both of the algorithm components are calculated as position demands.

In the present example, the second axis has an angle of 45°. This is convenient for most applications because it will intersect with both the side and top surfaces, it enables both of these surfaces to be scanned in a single scan. This is particularly important where measurement of the top surface is important, for example for teeth. For measurements of surfaces both parallel and perpendicular to the rotational axis 14, the second axis must be at an angle to the rotational axis and to the plane perpendicular to that axis.

An advantage of this method is that the angle of the second axis may be varied. FIG. 4 illustrates an object 30 having an undercut 32. In the embodiment above the second axis was angled at 45° to the axis of rotation (shown by dashed line 34). This allows measurement of an undercut at an angle of 45° or below. An undercut having an angle of greater than 45° is not intersected by the second axis angled at 45° and thus cannot be scanned using this profile. However if the angle of the second axis is changed, for example to 90° to the axis of rotation, this new second axis 36 now intersects the undercut which can be scanned using the spiral profile. The angle of the second axis can be changed during the scan. Thus objects with sharp undercuts can still be scanned in a single scan profile which has the advantage of enabling a fast scan. This is particularly relevant for scanning objects such as teeth which have undercuts.

The angle of the second axis may be changed automatically using stylus deflection data to determine when to change the angle. For example, referring to FIG. 4, the object 30 may be scanned upwards from at or near the bottom of the object using a horizontal second axis 36. When the stylus tip reaches the corner 38 of the undercut 32, the stylus will be deflected in −Z and the angle of the second axis will in response change automatically to 45°. Alternatively, the angle of the second axis may be changed at a predetermined position in Z.

The algorithms used to control the position of the probe will now be described with reference to FIG. 5.

In a first step the rotation angle demand for the next frame is calculated. (This can exceed 2Π.)
θ=ΩT
where θ is the rotation angle of the second axis Ω is the rotational velocity of the second axis and T equals time.

In a next step, the rotation matrix is created:

$$Rotation := ( \begin{matrix}cos ( θ ) & - sin ( θ ) & 0 \\ sin ( θ ) & cos ( θ ) & 0 \\ 0 & 0 & 1\end{matrix} )$$

Where “Rotation” is the rotation matrix.

In a next step the sensor axis direction is calculated:

$$Direction := Rotation [ \begin{matrix}\frac{1}{\sqrt{2}} \\ 0 \\ \frac{1}{\sqrt{2}}\end{matrix} ]$$

Where “Direction” is the sensor axis direction.

The origin translation in z due to the thread pitch is then calculated.

$$Origin := [ \begin{matrix}0 \\ 0 \\ \frac{θ}{2. π} . Pitch\end{matrix} ]$$

Where “Origin” is the origin translation in z and “Pitch” is the thread pitch.

Next the scan position demand is calculated. This is the nearest point on the second axis to the current machine position, where “machine” is the position of the centre of the stylus ball when there is no deflection.

ScanPositionDemand:=[(Machine−Origin).Direction].Direction+Origin

The probe deflection error is calculated from:

Deflection error:=|Probe deflection|−Nominal deflection

Where “Probe deflection” is the actual probe deflection and “Nominal deflection” is the desired probe deflection.

The probe deflection error is used to calculate the deflection control vector:

ProbePositionDemand:=DefError.Direction

Where “DefError” is the probe deflection error and “direction” is the direction parallel to the second axis along which the probe is moved.

The position demand vector can thus be determined from the deflection control vector and the scan position demand vector:

PositionDemand:=ScanPositionDemand+ProbePositionDemand

The velocity demand can thus be created:

$$VelocityDemand := \frac{PositionDemand - Machine}{δ t}$$

Although the above description describes the use of a contact probe, the method is also suitable using a non-contact probe e.g. an optical, capacitance or inductance probe. If a 1-D non-contact probe is used, the probe will need to be rotated to keep it directed at the surface of the object as the probe follows the spiral profile for example it may be directed towards the rotational axis of the spiral path. However using this method, the direction in which the probe must face is known. Offset of the non-contact probe may be adjusted by moving the probe parallel to the second axis in a similar manner to how probe deflection is adjusted for a contact probe.

1. A method for scanning an object with a surface measurement probe mounted on a coordinate positioning machine, the probe having a definable servo direction vector, the method comprising the steps of:
using translational movement of the coordinate positioning machine to move the probe along an at least part nominally spiral path about an axis which intersects the object;
wherein the servo direction vector for the probe is directed nominally towards the axis of the at least part nominally spiral path;
and wherein the servo direction vector for the probe is at an angle to said axis of the nominally spiral path and at an angle to a plane perpendicular to said axis of the at least part nominally spiral path.

2. A method according to claim 1 wherein the object has an unknown surface profile.

3. A method according to claim 1 wherein the object has a free form surface.

4. A method according to claim 1 wherein the surface measurement probe comprises a contact probe having a deflectable stylus.

5. A method according to claim 4 wherein the method comprises a further step of moving the probe parallel to the direction of the probe servo direction vector of the probe to control probe deflection.

6. A method according to claim 1 wherein the surface measurement probe comprises a non contact probe.

7. A method according to claim 6 wherein the method comprises a further step of moving the probe parallel to the direction of the probe servo direction vector of the probe to control probe offset.

8. A method according to claim 6 wherein as the probe moves along the at least part nominal spiral path, it is rotated to keep its line of sight directed towards the axis which intersects the object.

9. A method according to claim 1 wherein the method includes the step of maintaining the probe on the nominally spiral path by movement of the probe perpendicular to the direction of the servo direction vector of the probe.

10. A method according to claim 1 wherein translational movement of the coordinate positioning machine to move the probe along an at least part nominally spiral path about an axis which intersects the object is achieved by:
defining a second axis along which the probe servo direction vector is parallel, said second axis being at an angle to said axis which intersects the object;
rotating the second axis for an at least part revolution about the first axis and translating the second axis in a direction parallel to the first axis;
moving the surface measurement probe to keep it on the axis.

11. A method according to claim 7 wherein the second axis intersects the surface of the object to be measured.

12. A method according claim 1, wherein the servo direction vector of the probe is angled at 45 degrees to the axis intersecting the part.

13. A method according to claim 1, wherein the angle between the probe direction vector and the axis which intersects the object is varied during the scan.

14. A method for scanning an object with a surface measurement probe comprising the steps of:
defining a first axis of the object;
defining a second axis, said second axis being at an angle to the first axis;
rotating the second axis for an at least part revolution about the first axis and translating the second axis in a direction parallel to the first axis;
moving the surface measurement probe to keep it on the second axis.

15. A method for scanning an object according to claim 14 wherein the probe is servoed in the direction of the second axis to keep the probe at the desired distance from the object.

16. A method according to claim 14 wherein the probe is servoed a direction perpendicular to the second axis to keep the probe on the second axis.

17. Apparatus for scanning an object comprising:
a surface measurement probe mounted on a coordinate positioning machine, said coordinate positioning machine having drive means to enable the probe to be driven translationally in several axes;
a controller which controls said drive means to move the probe along an at least part nominally spiral path about an axis which intersects said object;
wherein the controller controls the drive means such that the servo direction vector of the probe is directed nominally towards the centre of said axis of the at least part nominally spiral path;
and wherein the controller controls the drive means such that the servo direction vector of the probe is at an angle to said axis of the at least part nominally spiral path and at an angle to a plane perpendicular to said of the at least part nominally spiral path.
